(19) United States
(12) Patent Application Publication
(10) Pub. No.: US 2017/0225504 A1
(43) Pub. Date: Aug. 10, 2017

(54) Rapid loading security pen

(71) Applicant: James Joseph Redfern, Victoria (CA)

(72) Inventor: James Joseph Redfern, Victoria (CA)

(21) Appl. No.: 14/998,720

(22) Filed: Feb. 8, 2016

(51) Int. Cl. B43K 23/00; B43K 29/00

(52) U.S. Cl. CPC B43K 23/001; B43K 29/00

(57) ABSTRACT

A writing instrument with no moving parts comprising of a rigid primary barrel (2) abutting a deformable elastomeric finger grip element (6) both with a communicating longitudinal through bore (4) (20) devoid of any ink cartridge or refill. The through bore of the primary barrel (4) is formed to accept a common disposable stick pen or common pencil (16). The through bore (20) of the elastomeric finger grip element (6) is formed to be slightly narrower in diameter than the outside diameter of a disposable stick pen (16) or pencil and thus captures an inserted stick pen by way of friction. The elastomeric grip is the sole means for retaining a stick pen or pencil used as a refill within the writing instrument barrel. The primary barrel has formed to it an integral, parallel, secondary barrel (12) that retains a ball chain (14) or cable to be secured to an object or a work station to discourage theft.

### CROSS REFERENCE TO RELATED APPLICATIONS

This patent claims the benefit of provisional patent application Ser. No. 62/176,122 filed Feb. 10, 2015 by the present inventor.

### FEDERALLY SPONSORED RESEARCH

Not applicable

### SEQUENCE LISTING OR PROGRAM

Not Applicable

### BACKGROUND OF THE INVENTION

Field of Invention

This invention relates to an improved security pen, also known as a counter pen, specifically the type that is tethered by chain or cable to a service counter to prevent removal of the pen from the counter or work station.

Prior Art

Businesses, institutions and governments world-wide use counter pens or security pens at their service counters to prevent the accidental or purposeful removal of pens that are provided to customers for their signature or to fill out a form.

The current selection of security pens available is basic, unattractive, not brandable and of varying quality. Most models available today are refillable with new ink refills but some are not, they must be discarded. There is one common problem with all security pens currently available. The one common liability that virtually all prior art in the security pen category possess is the actual pen component. The refilling process for security pens with fresh refills is a burdensome task. It is the pain point. One must disassemble the pen and determine which specific refill their model of security pen requires. There are at least five standard refills available for the security pen product category. New refills must be ordered from a stationary supplier on-line or by telephone. A waiting period for product to be delivered exists. Once new refills are delivered the dysfunctional pen must be disassembled, refilled and reassembled. An inventory of refills ordered must be stored in a location that must be remembered at some future date when the refilling process must be repeated. This entire process is a frustration for those assigned with the task of maintaining the security pens in their operation.

Businesses, institutions and governments worldwide use security pens at service counters. Prior art has not offered a substantive innovative solution to the common frustration of the refilling process. The frustrating task of refilling a security pen with a fresh refill is universal.

Prior art appears to be concerned with other aspects of security pen issues such as the tethering system, holders and caddies. U.S. Pat. No. 6,854,681 to Kish, February 2005 discloses a retractable pen/stylus holder. U.S. Pat. No. 5,947,623 to Smith, September 1999 discloses a recoiling, replaceable chain marking device. U.S. Pat. No. 7,059,797 to Sellars, June 2006 discloses a writing instrument with simultaneous features for promotion and discouraging theft. U.S. Pat. No. 6,167,596 to Berman, January 2001 informs us of a pen and holder requiring no tools for replacement of a used up pen. U.S. Pat. No. 8,172,474 to Dickover et al, May 2012 discloses a hollow bodied writing instrument titled ‘Pen tether compressive disconnect.’ Although security pens possess numerous liabilities the main issue is the ongoing and frustrating challenge to replace old refills with fresh refills.

Objects and Advantages

There are numerous objects and advantages of the present invention. These are:
a) To provide a security pen with no moving parts to disassemble or reassemble.
b) To provide a security pen that is open at both ends for the sake of simplicity.
c) To provide a security pen that does not require special refills.
d) To provide a security pen that conveniently reloads with any brand of common disposable stick pen or common pencil.
e) To provide a security pen that reloads with a fresh refill rapidly in less than ten seconds.
f) To provide a security pen constructed with a deformable elastomer in the finger contact area for ergonomic comfort.
g) To provide a security pen wherein the deformable elastomer finger grip would be the sole means to grasp and retain an inserted disposable stick pen by way of compressive friction.
h) To provide a security pen that has a rigid barrel component with sufficient area upon which promotional printing or logos can be placed.
i) To provide a security pen that is attached to a pen stand or independent object by the use of a cable or ball chain that can be easily removed and replaced for repair.

### SUMMARY

In accordance with the present invention a writing instrument device with a through bore devoid of an ink cartridge comprising of an elongated, rigid, substantially cylindrical body abutting a deformable finger grip element also with a through bore that accepts common disposable stick pens or common pencils as a refill and means to attach a tethering element such as a cable or ball chain to the writing instrument's rigid barrel for security purposes.

### DRAWINGS—FIGURES

FIG. 1A—is a side view of the security pen with the elastomeric finger grip component, primary barrel and secondary barrel shown.

FIG. 1B—is a side view of the security pen with a ball chain (14) affixed to the secondary barrel and a disposable stick pen (16) inserted into the through bore.

FIG. 1C is a top plan view of security pen.

FIG. 2A—is an exploded, front elevation view of the preferred embodiment of the security pen sleeve with the deformable grip component removed from the primary body.

FIG. 3A—is a cross section of secondary barrel (12)

FIG. 3B—is a bottom end view of the primary barrel

FIG. 3C—is a bottom view of elastomeric finger grip

### DRAWINGS—REFERENCE NUMERALS

2—primary barrel

4—through bore of primary barrel

6—elastomeric finger grip component

8—orifice of through bore

10—projecting bushing of primary barrel

12—secondary barrel

14—ball chain

16—disposable stick pen

18—orifice of through bore of secondary barrel

20—through bore of elastomeric finger grip

22—orifice of through bore

24—pendant

### DETAILED DESCRIPTION

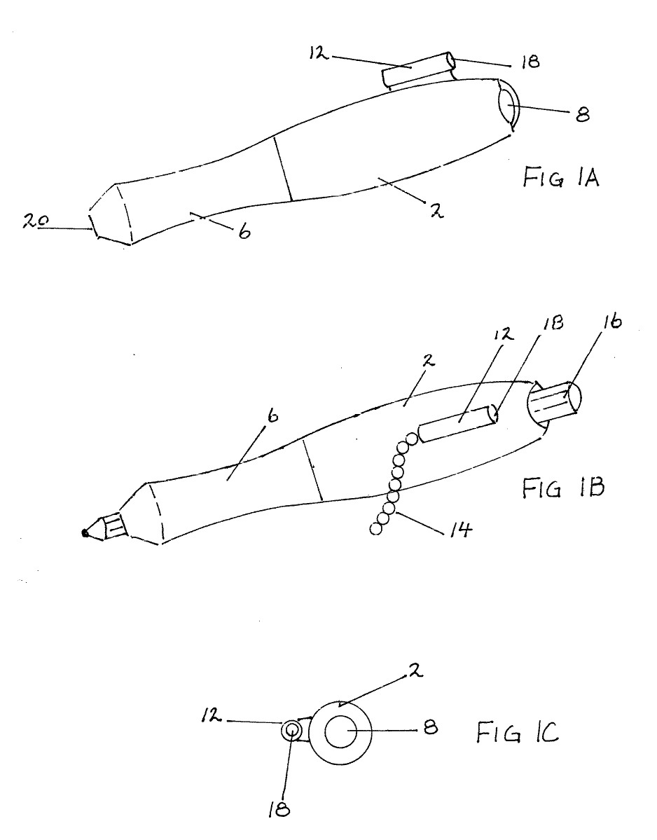

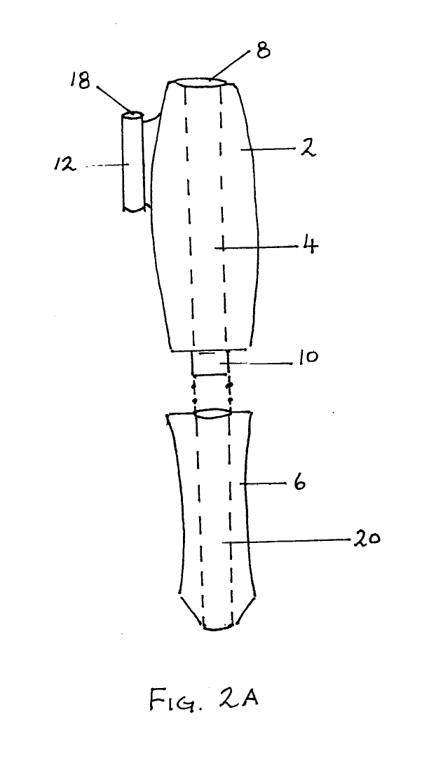

A preferred embodiment of the security pen is illustrated in FIGS. 1A, 1B, and 2A.

FIG. 2A—Description of Primary and Secondary Barrels

A primary barrel 2 is formed to create a rigid, generally cylindrical barrel with a through bore 4 along the longitudinal axis. The primary barrel 2 could be injection molded of a thermoplastic material which is the preferred embodiment. The through bore 4 would be sized to accept any disposable stick pen 16 presently in use. The through bore of the primary barrel 4 would be formed to have a greater inside diameter than the outside diameter of any stick pen available. The primary barrel 2 could also be formed of wood, bamboo or synthetic material using various methods such as turning on a lathe which would result in a cylindrical barrel.

The secondary barrel 12, adjacent to primary barrel 2 would be integrally formed to the primary barrel. The internal diameter of the through bore 18 of the secondary barrel 12 would accept a ball chain, the preferred embodiment, or a narrow cable. The internal walls of through bore 18 would be tapered from top to bottom, wider at the top. A ball chain 14 affixed with a pendant 24 at its distal end would be permitted to enter the bore at the top end of the secondary barrel but the pendant would be prevented from exiting at the lower end due to the reduced internal diameter of the through bore 18 at the lower end.

FIG. 2A—Description of Primary Barrel Bushing

FIG. 2A shows the primarily barrel 2 would be reduced in diameter at its lower end to form an integral bushing 10. Bushing 10 would be the connection point between the primary barrel 2 and the elastomeric finger grip 6. The outside diameter of the Bushing would be approximately that of the inside diameter of the finger grip 6. Bushing 10 would be inserted into the through bore 20 of finger grip 6 and permanently affixed with a suitable adhesive. There are various possibilities with regard to affixing the primary barrel to the finger grip but the one presented is the preferred embodiment.

FIG. 2A—Description of Elastomeric Finger Grip

The elastomeric finger grip 6 would have a through bore 20 whose internal diameter would be less than the diameter of stick pens currently available. Finger grip 6 would abut the main barrel and be attached by means of inserting the projecting bushing 10 into the through bore 20 of the finger grip. It could be permanently affixed with a suitable adhesive. This is the preferred embodiment although there are various methods of mating the finger grip component to the primary barrel.

Description—Other methods of mating finger grip 6 to primary barrel 2:
1. A bushing could be permanently affixed with adhesive into the through bore 20 of the finger grip 6 and could be bayonet mounted, screw thread mounted, or friction fitted into the main body of the primary barrel whose internal diameter would be configured to accept either a bayonet or screw thread or friction fit arrangement.
2. The elastomeric finger grip 6 could be co-injection molded and permanently affixed directly to the projecting bushing 10 on the lower end of the rigid barrel 6.

Operation

The user of the present invention would grasp the primary barrel 2 with one hand and with the other hand insert the ball point end of a disposable stick pen 16 into the primary barrel. The stick pen 16 would be inserted into the top end orifice 8 of the primary barrel 2 and be pushed through the longitudinal bore 4 of the barrel 2 until the ball point of the inserted stick pen protrudes through the bottom of elastomeric finger grip 6. As the disposable stick pen 16 passes through the primary barrel 2 it makes little or no contact with the interior wall of the barrel 2 because the primary barrel is formed to have an internal diameter slightly greater than the maximum outside diameter of any common stick pen or common pencil presently available. Stick pens have very similar outside diameters and are similar in diameter to common pencils.

As the inserted stick pen 16 continues its journey through the primary barrel 2 it eventually reaches the elastomeric finger grip 6. The stick pen will now experience resistance because the internal diameter of the finger grip 6 is formed to be less than the outside diameter of the common disposable stick pen being inserted. Being an elastomer, the internal walls of finger grip 6 will offer radial pressure against the walls of the stick pen. To reiterate, outside diameters of stick pens are very similar and differ by minute, insignificant dimensions. The elastomer expands to accept the stick pen. The elastomeric material has a high co-efficient of friction and the internal walls of finger grip 6 will grip the inserted stick pen effectively. As the writer bears down with pressure as he or she writes, pinch pressure offered by the writer's fingers further adds to the arresting forces within the elastomeric finger grip. Thus the stick pen has no tendency to slide upwards within the through bore of the security pen despite being open ended at the top of the barrel.

Having open ends and with no moving parts to disassemble and reassemble the Rapid Loading Security Pen offers ease and speed during the reloading process. Its ability to accept any brand of stick pen as the refill offers the user unprecedented convenience.

During the reloading process of the primary barrel 2 the user should hold the primary barrel only and avoid touching the elastomeric grip while removing a stick pen. The stick pen will slide out of both the primary barrel and the elastomeric finger grip with little resistance.

Operation of the Secondary Barrel

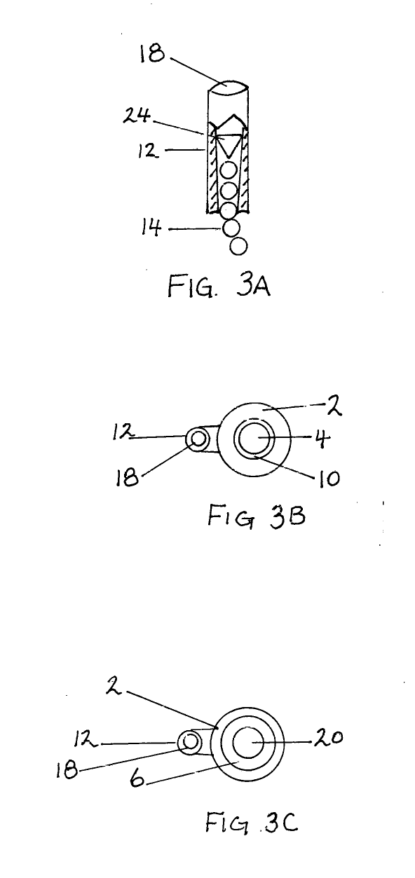

Tile secondary barrel 12 captures a ball chain 14 as shown is cross section FIG. 3A. The ball chain 14 permits the security pen to be attached to a pen stand, a counter top or some other object that would prevent the removal of the security pen from the service counter or work station.

FIG. 3A shows a pendant 24 is affixed to the end of the ball chain 14. The ball chain is inserted into the top end of the through bore 18 of the secondary barrel 12. The chain is guided into the through bore until the pendant enters the secondary barrel 12. The internal diameter of the through bore is tapered; wider at the top and narrowing towards the bottom of secondary barrel 12.The top end of the bore would be large enough to accept the pendant. The bottom end of the bore would taper to a diameter that would only permit the chain to exit the bore. The pendant's travel is eventually arrested by the narrowing through bore and the ball chain is securely but removably affixed inside the secondary barrel.

### Alternative Embodiments

There are numerous ways to construct my invention as this would be obvious to those skilled in the relevant arts.
1. A magnetic metal band or plate could be affixed to the primary barrel so that the barrel could be attracted to and held by a magnet for unique mounting and presentation possibilities.
2. The primary barrel 2 could be formed in an eccentric rather than cylindrical shape in order to present a larger, flatter barrel surface that would more readily accept printing of logos and brands for advertising purposes.

The exemplary embodiment described above has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

### CONCLUSION AND RAMIFICATIONS

The reader will see that this improved security pen is superior to prior art in a number of ways.
The rapid and easy insertion of stick pens as the refill obviates the necessity to order specialized refills
The use of common stick pens as the refill is economical.
There is a degree of practicality, ease and convenience considering the ubiquitous nature of stick pens
It provides a rigid barrel with substantial surface area on which to print indicia.
It provides a tethering mechanism that is easy to repair if need be.
With no moving parts to disassemble the security pen is fast to reload.

I claim:

1. In a hand held writing instrument comprising:
a) no moving parts
b) a longitudinal through bore devoid of an ink reservoir or a refill cartridge.
c) an elongated, substantially cylindrical, rigid body abutting
d) an elongated, cylindrical, deformable, finger grip element and
e) a means for removably affixing a tethering element to said cylindrical rigid body

2. The writing instrument of claim 1 wherein said longitudinal through bore of said rigid body would be sized and configured to accept a common disposable stick pen or a common pencil.

3. The writing instrument of claim 1 wherein said cylindrical, deformable finger grip element is formed to have an internal diameter narrower than the outside diameter of said common disposable stick pen or common pencil.
